(19) United States
(12) Patent Application Publication
(10) Pub. No.: US 2025/0197257 A1
(43) Pub. Date: Jun. 19, 2025

(54) CHEMICAL COMPOSITION FOR INCREASING DENSITY OF LIQUIDS

(71) Applicants: ABDOH IBRAHIM Y AUTEF, Dist. Riyadh (SA); Antonio IBÁÑEZ DE ALBA, Daimiel (Ciudad Real) (ES)

(72) Inventor: Antonio IBÁÑEZ DE ALBA, Daimiel (Ciudad Real) (ES)

(73) Assignee: ABDOH IBRAHIM Y AUTEF, Dist. Riyadh (SA)

(21) Appl. No.: 18/847,672

(22) PCT Filed: Mar. 15, 2023
(86) PCT No.: PCT/EP2023/056666

§ 371 Date: Sep. 16, 2024

(30) Foreign Application Priority Data
Mar. 15, 2022 (ES) P202200019

(51) Int. Cl. C02F 1/68; C02F 1/50; C02F 103/42

(52) U.S. Cl. CPC C02F 1/68; C02F 1/50; C02F 2103/42; C02F 2209/01; C02F 2209/05; C02F 2305/00

(57) ABSTRACT

A chemical composition for increasing density of liquids such as water for sports, bathing, leisure and/or rehabilitation uses includes in weight percentage: potassium citrate, between 1.2% and 63%; sodium citrate, between 1.5% and 66%; potassium chloride, between 2.2% and 97%; potassium ascorbate, between 5.1% and 94%; and sodium benzoate, between 1.03% and 22%. The components are water-soluble salts, environmentally friendly, which are common food additives, what makes them safety for humans. The composition can be added to water of swimming pools, ponds, tanks, rafts, bathtubs or artificial beaches, where it increases density, increasing floatability and facilitating the practice of sports, swimming, bathing or other leisure activities. It also helps to prevent development of microorganisms or other polluting substances and to diminish freezing point of the water where it has been added.

### TECHNICAL FIELD

The present invention relates to the field of the chemical industry and, more particularly, to the development of a new composition with suitable properties to increase the density of liquids. The invention also refers to multiple applications of the new composition, both in swimming pools and sports use.

### BACKGROUND OF THE INVENTION

Increasing the density of water where sports and leisure activities or rehabilitation take place is a field of interest for several reasons, including the associated increase of buoyancy and floatability which can be observed, which facilitates swimming to unexperienced people and decreases effort required for the practice of sports such as water polo or for movements of injured or weakened people.

Many approaches have been inspired by the composition of the Dead Sea, where the high salinity gives rise to high floatability and, additionally to the lack of animal and plant life. Such approaches have focused in adding salts to water, in order to achieve a composition similar to that of the Dead Sea, wherein the mean salt content is 331.7 g/l and chlorides (sodium, magnesium, calcium and potassium chloride) are the main salts, bromides and sulphates being also present.

Thus, for instance, Spanish patent application ES2224788A1 discloses adding chloride salts to water with the aim of increasing density, wherein water use is proposed for sports, swimming pools, rehabilitation baths, ponds or artificial beaches. A formulation comprising 4.66 g of potassium chloride, 466.56 g of sodium chloride and 528.78 g of magnesium chloride in 1 kg of dry product is disclosed. Due to its high content in salts, the formulation can control microbial contamination and results in a decrease of the freezing point when added to water.

A similar approach can be found in Chinese patent application CN1249166A, which discloses a place similar to Dead Sea for swimming and playing containing water to which a composition has been added which contains 60% sodium chloride, 30% calcium chloride, 10% potassium chloride. It is preferred that the suitable amount of the composition is added so that the specific weight is higher than that of human body and the human body can float over the water.

A composition for regulating water density comprising a mixture of calcium, sodium and magnesium chlorides is also disclosed in Spanish patent application ES2155372A1, wherein the compounds can be formulated in any proportion. The main application of the composition is increasing density in water for swimming pools and rehabilitation baths, in order to increase people floatability.

United States patent application U.S. Pat. No. 4,945,908A discloses an apparatus and a process for phototherapy combining irradiation similar to the one that could be received in Dead Sea area with a bath with water with a composition resembling that of Dead Sea water, comprising magnesium, calcium, sodium, potassium, strontium, lithium, chloride, bromide, sulfate, hydrogen carbonate and other salts.

As it is considered that high chloride content, particularly sodium chloride and magnesium chloride, is corrosive and increases rust, chloride content has been tried to be reduced in many compositions and formulations with other water-soluble salts have been proposed for increasing water density.

As another prior art closest to the present invention, different carbonates, such as potassium carbonate, can be mentioned, which allow increasing the density of liquids, but have the problem of being very corrosive and oxidizing. A similar problem can be found with some other salts and acids, such as phosphoric acid, aluminium chloride, sodium sulfate, sulfuric acid, which are compounds with multiple properties, among which it is worth mentioning its ability to increase the density of liquids with the disadvantage of its corrosive and oxidizing effect. Thus, they are not suitable for many of the sports, recreational and bathroom applications in pools.

International patent application WO2016/113443 discloses a formulation for increasing water density comprising sodium gluconate, monosodium glutamate, magnesium chloride, sodium chloride, sodium carbonate, magnesium carbonate and glycerin. Thus, the composition is based on sodium and magnesium salts. The formulation is used to increase the density of water, for rehabilitation pools, swimming pools, spas, tanks, reservoirs, artificial beaches, competitive sports pools, as well as for skin disorders. Additionally to comprising carbonates, another of the components is monosodium glutamate, a compound that is known to produce some intolerances when added to food, particularly Chinese food, so that is presence in water can be a cause of concern for some people. Sodium gluconate, in turn, when added to water, is a compound known to give rise to a sort of paste after time.

In industrial fields remote from the field of the present invention (which is the field of modification of water intended for sports, leisure, bathing and rehabilitation and therapy applied to human therapy, where the chemically modified water is expected to contact human skin and accidental ingestion of water cannot be discarded), other compositions for increasing water density have been proposed where the use of chlorides is avoided. For instance, Spanish patent application ES2843423A1 discloses a formulation comprising potassium citrate, sodium citrate, monoethylene glycol, monopropylene glycol and azoles. The composition is specially designed for the industry of wind aerogenerators and exhibits a very high density that would make difficult, or almost impossible, any movement of a person that could have a part of, or the whole the body, introduced into that composition. Additionally, two of the compounds, monoethylene glycol and monopropylene glycol can be a threat to the environment, because they can easily penetrate the soil and contaminate groundwater and nearby streams; moreover, its use as non-reacted components in formulations for direct internal or external human/animal contact, including ingestion, inhalation and skin contact, is not recommended.

It would be advisable to design a composition for increasing water density that could overcome the drawbacks of other compositions of the state of art designed for that purpose, being suitable for being added to water intended to be used for sports, swimming, bathing and leisure activities of human beings, or rehabilitation baths, where people can move but with an increased density which could make people's movements easier, more comfortable and less painful; where the use of chlorides (particularly, sodium and magnesium chloride) is avoided or reduced, which composition includes not expensive water-soluble salts, where the number of components is not very high in order to simplify the preparation and reducing costs, comprising components not hazardous for the environment or human health, which are preferably already used for cosmetic and/or medicinal purposes and also, and preferably, which are already authorized as food additives or have been traditionally used for culinary purposes (thus minimizing the risk of adverse reactions if they are accidentally ingested), and, if possible, not being known to provoke allergic reactions, so that their presence is not likely to provoke any rejection by the water users. Also preferably, at least one or as much as possible of the components should have high density by themselves, helping to minimize the necessary amount to use, and/or have preservation properties by themselves. And, in order to design such composition, compounds such as gluconates (which forms easily a paste when added to water, particularly after a time of having been added) should be avoided, in order to prevent the appearance of unpleasant and unaesthetic lumps, scaling deposited in the water reservoir or gelation of the liquid where people are bathing, swimming, playing any other sport or receiving rehabilitation therapy.

The present invention provides a solution to such a problem.

### DETAILED DESCRIPTION OF THE INVENTION

The present invention arises as a solution to the problems derived from the compositions of the state of the art. It is, therefore, a new formula with a composition that has proven to be particularly effective in increasing the density of liquids, especially water, without entailing the harmful, corrosive and oxidizing or unwanted effects of other products (such as risks of gelation or formation of a paste, risks for the environment or too high density which makes difficult people's movements) and comprising components already used as authorized food additives, cosmetic ingredients and/or medicament ingredients which would not make expectable harmful effects due to accidental ingestion.

Thus, the present invention relates to a new composition intended to increase density of a liquid, characterized in that it comprises, in weight percent:
potassium citrate, in a percentage comprised between 1.2% and 63%;
sodium citrate, in a percentage comprised between 1.5% and 66%;
potassium chloride, in a percentage comprised between 2.2% and 97%;
potassium ascorbate, in a percentage comprised between 5.1% and 94%;
sodium benzoate, in a percentage comprised between 1.03% and 22%.

Preferably, the liquid is water or an aqueous solution. More preferably, the liquid is water intended to be used for sports, bathing, swimming, recreation or leisure uses, or for rehabilitation baths.

The composition comprises components that are not particularly expensive, so that the addition to the composition to a liquid, particularly water or an aqueous solution, is an easy and economical way of increasing density of the liquid, especially water or aqueous solutions, particularly those for sporting, bathing or swimming uses, including bathing in rehabilitation pools or bathtubs where injured or aged people perform physical rehabilitation exercise to improve or accelerate recovery.

All components of the composition object of the invention have the additional advantage of being environmentally friendly. Besides, they are components that do not present any type of toxicity in small quantities; they are not corrosive or oxidizing either. Moreover, some of them are compounds that are in the list of food additives approved for use in foods in the European Union (Regulation (EU) No 1333/2008, what is an indication of safety when used in water for bathing and/or sport uses. Some of them, additionally, are compounds or salts of compounds that appear in reactions of or take part in the metabolism of human beings, animals and/or plants and which are present in plants traditionally consumed by human beings or, even, which are included in cosmetics and/or medicaments.

For instance, citrate is the ionized form of citric acid, one of the compounds that appear in the tricarboxylic acid metabolic pathway, the three-stage process by which living cells break down organic fuel molecules, in the presence of oxygen, to obtain the energy they need to grow and divide. Citric acid is present in many fruits, especially in citrus fruits such as orange, lemon and mandarin.

Potassium citrate (E-332 in the EU list of authorized food additives) is used to regulate acidity; for instance, it is used in many soft drinks as a buffering agent. Medicinally, it may be used to control kidney stones derived from uric acid or cystine and it is employed as a non-irritating diuretic. It exhibits a density of 1980 kg/m³ at 25° C. As indicated above, it can be present in the composition of the present invention in a weight percentage of 1.2%-63%. Preferably, it is present in a percentage selected from the group of 10%, 25%, 30% or 50% w/w (weight percent with regard to the total weight of the composition). It is particularly preferred that the percentage is 50% w/w.

Sodium citrate (E-331 in the EU list of authorized food additives) is also used to regulate acidity in foods and drinks. It is also used in cosmetics for pH regulation. Medicinally, it may be used as alkalinizing agent to neutralize excess acid in the blood and urine, for the treatment of metabolic acidosis and chronic kidney disease. It exhibits a density of 1700 kg/m³ at 25° C. As indicated above, it can be present in the composition of the present invention in a weight percentage of 1.5%-66%. Preferably, it is present in a percentage selected from the group of 10%, 25%, 30% or 50% w/w (weight percent with regard to the total weight of the composition). It is particularly preferred that the percentage is 10% w/w.

Potassium chloride is a natural occurring salt that is present, among others, in sea water. It is one of the leadings salts that is being used in food as a viable sodium chloride replacement. It is used as flavour enhancer, flavouring agent, nutrient supplement, pH control agent, stabilizer and thickener. It has been recognized as GRAS (Generally Recognized As Safe) by the U.S. Food and Drug Administration, having no limitation for its use in food manufacturing but those marked by the levels necessary to obtain its intended effect in a product. Considered vital in the human body, it is on the World Health Organization's List of Essential Medicines, being administered to treat low blood potassium, both orally and intravenously. It exhibits a density of 1980 kg/m³ at 25° C. As indicated above, it can be present in the composition of the present invention in a weight percentage of 1.5%-66%. Preferably, it is present in a percentage selected from the group of 10%, 25%, 30% or 50% w/w (weight percent with regard to the total weight of the composition). It is particularly preferred that the percentage is 30% w/w.

The presence of potassium chloride in the composition, in particular, means an additional advantage because it allows to use the composition to prevent freezing of the liquid (preferably, water or an aqueous solution) to which it is added, when the temperature is below −1 degree centigrade, even (and preferably) when the temperature is equal to or below −10 degrees centigrade.

Ascorbate is the ionized form of ascorbic acid. Ascorbic acid, in turn, is a compound which exits as two isomeric (enantiomeric) forms, L and D. The L-isomer occurs naturally in many foods and is one form of vitamin C, a compound essential for humans and animals because it is a coenzyme with antioxidant activity involved in numerous metabolic reactions which helps to prevent certain diseases such as cancer, cardiovascular diseases, common cold, age-related muscular degeneration and cataract. It is used as a food additive (E-300) and cosmetic ingredient due to its antioxidant properties.

The potassium salt of ascorbic acid, potassium ascorbate, also exhibits a strong antioxidant activity and antitumoral properties.

Sodium benzoate is a natural preservative used in food industry (E-211 in the EU list of authorized food additives) and cosmetics, mainly for its antifungal properties. Its presence in the composition of the present invention contributes to prevent the presence of microorganisms.

In a particularly preferred embodiment of the invention, compatible with all the previous ones, the composition is characterized in that it contains, in weight percent:
potassium citrate, in a percentage of 50%;
sodium citrate, in a percentage of 10%;
potassium chloride, in a percentage of 30%;
potassium ascorbate, in a percentage of 7%;
sodium benzoate, in a percentage of 3%.

The composition of the invention, in any of its embodiment, can be added to water within a broad range of concentrations which can vary from 1 g/cm³ to saturation.

It is also an object of the invention the use of the composition of the invention, or the use of a liquid (preferably water) characterized by comprising the composition object of the invention, for sports, bathing, swimming and/or leisure activities or for rehabilitation baths or pools. Being a liquid (water) for such purposes, a possible embodiment of that object of the invention is that the liquid is in a swimming pool, pond, tank, bathtub, raft, artificial beach or rehabilitation pool, or any other type of reservoir where a person can introduce a part of the body or the whole body. When the liquid is water, it is characterized by having a density greater than 1 g/l at room temperature (25° C.). Preferably, the use of the composition of the invention, specifically, will be for increasing density of a liquid which is water for sporting, swimming, bathing and/or leisure activities or for rehabilitation bathing; additionally, the composition can be used for preventing growth of microorganisms in the liquid (water).

As used in the present application, the term “water” is intended to encompass not only pure water, but it must be understood in its broad common meaning which refers to the liquid that descends from the clouds as rain, forms streams, lakes and seas, whose main component is water but which also includes, naturally or due to human activity, salts and other compounds dissolved or suspended in it and, usually, also viruses and microscopical living beings. The term “chemically modified water of the invention” or “chemically modified water object of the invention” refers specifically to water to which a composition of the invention has been added, so that it can be said that it comprises the composition object of the invention.

Among the numerous applications of the composition, the following can be mentioned, without being limited to:

The chemically modified water object of the invention is for all types of applications in sports use, bathing in pools, rafts. A particularly relevant application, especially in the case of the preferred embodiment of the invention, is the sports use and for bathing in pools or water ponds or artificial beaches for bathing. Also relevant is the use in rehabilitation baths and pools, where injured, or aged, people can move easily and carry out physical exercises to facilitate their recovery (particularly, recovery from muscular or bone lesions or degeneration) or maintain fitness but where movement results less painful.

Therefore, the applications of the new composition are numerous, which means an important advantage with respect to other formulations described in the state of the art. As previously mentioned, unlike other compositions known to increase the density of water, the present formulation does not present any type of effect harmful to people's health.

Likewise, as a consequence of the presence of salts in the chemically modified water, it is possible to avoid growth and/or development of microorganisms or other polluting substances in it, a property that is favoured by the presence of sodium benzoate, as explained above. This means an additional advantage since, in this way, it will not be necessary to use decontaminating chemical substances in large quantities, which often cause contamination of water.

Due to its composition, particularly thanks to the presence of potassium chloride, the chemically modified water comprising the composition of the invention is ideal for withstanding low temperatures without freezing below minus −1 degrees centigrade (Celsius), preferably −10 degrees centigrade (Celsius). Thus, it can be considered that another aspect of the present invention is a procedure for preventing freezing of water and/or an aqueous solution in a swimming pool, pond, bathtub, raft, artificial beach or rehabilitation pool which is at a temperature below −1 degrees centigrade, preferably at a temperature equal to or below −10 degrees centigrade, wherein a composition of the invention is added to the water and/or aqueous solution.

### EXAMPLE

With the aim of testing the advantages of the formulation object of the invention, an assay was carried out for which a formulation in accordance with the particularly preferred composition disclosed in the previous section was added. Specifically, a formulation was prepared that was characterized by containing, in weight percentage:
potassium citrate, in a percentage of 50%;
sodium citrate, in a percentage of 10%;
potassium chloride, in a percentage of 30%;
potassium ascorbate, in a percentage of 7%;
sodium benzoate, in a percentage of 3%.

This formulation was added to a volume of 1 litre of water. Next, the salts were mixed at room temperature, subjecting the mixture to stirring until obtaining a homogeneous mixture. Freezing was not observed at low temperatures below minus −1 to −10 degrees centigrade.

Subsequently, a buoyancy test was carried out by introducing a heavy object into the chemically modified water, which floated on the surface of the water, thus demonstrating the density of the modified water with the composition object of the invention.

1.-14. (canceled)

15. A chemical composition for increasing density of a liquid comprising:
in weight percentage:
potassium citrate, in a percentage comprised between 1.2% and 63%;
sodium citrate, in a percentage comprised between 1.5% and 66%;
potassium chloride, in a percentage comprised between 2.2% and 97%;
potassium ascorbate, in a percentage comprised between 5.1% and 94%; and
sodium benzoate, in a percentage comprised between 1.03% and 22%.

16. The chemical composition according to claim 15, wherein, in weight percentage, potassium citrate in a weight percentage is selected from the group of 10%, 25%, 30 and 50%.

17. The chemical composition according to claim 15, wherein, in weight percentage, sodium citrate in a weight percentage is selected from the group of 10%, 25%, 30% and 50%.

18. The chemical composition according to claim 15, wherein, in weight percentage, potassium chloride in a weight percentage is selected from the group of 10%, 25%, 30% and 50%.

19. The chemical composition according to claim 15, where, the composition comprises:
in weight percentage:
potassium citrate, in a percentage of 50%;
sodium citrate, in a percentage of 10%;
potassium chloride, in a percentage of 30%;
potassium ascorbate, in a percentage of 7%; and
sodium benzoate, in a percentage of 3%.

20. The chemical composition according to claim 15, wherein the liquid is water.

21. The chemical composition according to claim 20, where the liquid is water for sporting, swimming, bathing, or leisure activities or for rehabilitation baths.

22. A method of using a chemical composition for increasing density of a liquid comprising:
in weight percentage:
potassium citrate, in a percentage comprised between 1.2% and 63%;
sodium citrate, in a percentage comprised between 1.5% and 66%;
potassium chloride, in a percentage comprised between 2.2% and 97%;
potassium ascorbate, in a percentage comprised between 5.1% and 94%; and
sodium benzoate, in a percentage comprised between 1.03% and 22%.
the method of using the chemical composition comprises:
sporting, swimming, bathing, or leisure activities or for rehabilitation bathing.

23. The method of claim 22, wherein the liquid is water.

24. The method of claim 22, wherein the liquid is in a swimming pool, pond, tank, bathtub, raft, artificial beach, or rehabilitation pool.

25. The method of claim 22, wherein the water is used for sporting, swimming, bathing, or leisure activities or for rehabilitation bathing.

26. The method of claim 25, wherein the chemical composition is used for preventing growth of microorganisms.

27. A method for preventing freezing of water or freezing an aqueous solution in a swimming pool, pond, tank, bathtub, raft, artificial beach or rehabilitation pool which is at a temperature below −1 degrees centigrade, the method comprising the step of:
adding a chemical composition to the water or aqueous solution,
wherein the chemical composition comprises:
in weight percentage:
potassium citrate, in a percentage comprised between 1.2% and 63%;
sodium citrate, in a percentage comprised between 1.5% and 66%;
potassium chloride, in a percentage comprised between 2.2% and 97%;
potassium ascorbate, in a percentage comprised between 5.1% and 94%; and
sodium benzoate, in a percentage comprised between 1.03% and 22%.

28. The method of claim 27, wherein the water or aqueous solution is at a temperature equal to or below −10 degrees centigrade.
